(19) United States
(12) Patent Application Publication
(10) Pub. No.: US 2010/0325897 A1
(43) Pub. Date: Dec. 30, 2010

(54) LOCK MECHANISM AND A FOLDING KNIFE WITH THE SAME

(76) Inventor: Hui-Tung Chu, Luchou City (TW)

Correspondence Address: APEX JURIS, PLLC, 12733 LAKE CITY WAY NORTHEAST, SEATTLE, WA, 98125, US

(21) Appl. No.: 12/490,734

(22) Filed: Jun. 24, 2009

(51) Int. Cl. B26B 3/06

(52) U.S. Cl. 30/161

(57) ABSTRACT

A lock mechanism for a folding knife has a first cover, a first casing, a block and a resilient sheet. The block is mounted pivotally on the first cover. The resilient sheet is mounted adjacent to the block. The tang of the blade of the folding knife abuts the block. When operating the knife in one hand, a thumb is used to press the block and disengage the blade. Then a forefinger can be safely used to press the back of the blade into the chamber of the hilt. Therefore, the folding knife is safely folded.

### BACKGROUND OF THE INVENTION

1. Field of the Invention

The present invention relates to a folding knife, and more particularly to a lock mechanism for the folding knife.

2. Description of the Prior Arts

Folding knives are small, easy to use, convenient to carry and can be operated in one hand rapidly. Folding knives are widely used and are adapted for outdoor activity or emergency assistance.

With reference to FIG. 9, a conventional folding knife so called as a liner lock has a hilt (60) and a blade (70). The hilt (60) has a first cover (61), a second cover (62) and a chamber (63). The first cover (61) has a side and a resilient slice (64). The resilient slice (64) is formed on the side of the first cover (61) and has a tang. The second cover (62) is attached to the first cover (61). The chamber (63) is defined between the first cover (61) and the second cover (62). The blade (70) is mounted pivotally between the first cover (61) and second cover (62) of the hilt (60) and has a tang and a back. The tang of the blade (70) abuts the tang of the resilient slice (64).

The knife is held in one hand and a thumb (80) used to push the resilient slice (64) to disengage the tang of the blade (70), then a forefinger is used to press the back of the blade (70) into the chamber (63) of the hilt (60).

However, when folding the conventional folding knife in one hand, the thumb (80) is in a pivoting path of the blade (70) so is easily cut by the blade (70). Moreover, when using the conventional folding knife, the resilient slice (64) may disengage the tang of the blade (70) due to collision or applying too much force to the blade (70).

To overcome the shortcomings, the present invention provides a folding knife with safety folded feature to mitigate or obviate the aforementioned problems.

### SUMMARY OF THE INVENTION

The primary objective of the present invention is to provide a lock mechanism for a folding knife.

The lock mechanism for a folding knife has a first cover, a first casing, a block and a resilient sheet. The block is mounted pivotally on the first cover. The resilient sheet is mounted adjacent to the block. The tang of the blade of the folding knife abuts the block. When operating the knife in one hand, a thumb is used to press the block and disengage the blade. Then a forefinger can be safely used to press the back of the blade into the chamber of the hilt. Therefore, the folding knife is safely folded.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a folding knife with a lock mechanism in accordance with the present invention;

FIG. 2 is an exploded perspective view of the folding knife with a lock mechanism in FIG. 1;

FIG. 3 is an operational perspective view of the folding knife with a lock mechanism in FIG. 1 with a hand;

FIGS. 4 and 5 are operational side views of the folding knife with a lock mechanism in FIG. 1;

FIGS. 6 and 7 are operational end views in partial section of the folding knife with a lock mechanism in FIG. 1;

FIG. 8 is an operational perspective view of the folding knife with a lock mechanism in FIG. 1, showing the blade folded in the chamber of the hilt; and

FIG. 9 is a side view of a conventional folding knife in accordance with the prior art.

### DETAILED DESCRIPTION OF THE PREFERRED EMBODIMENTS

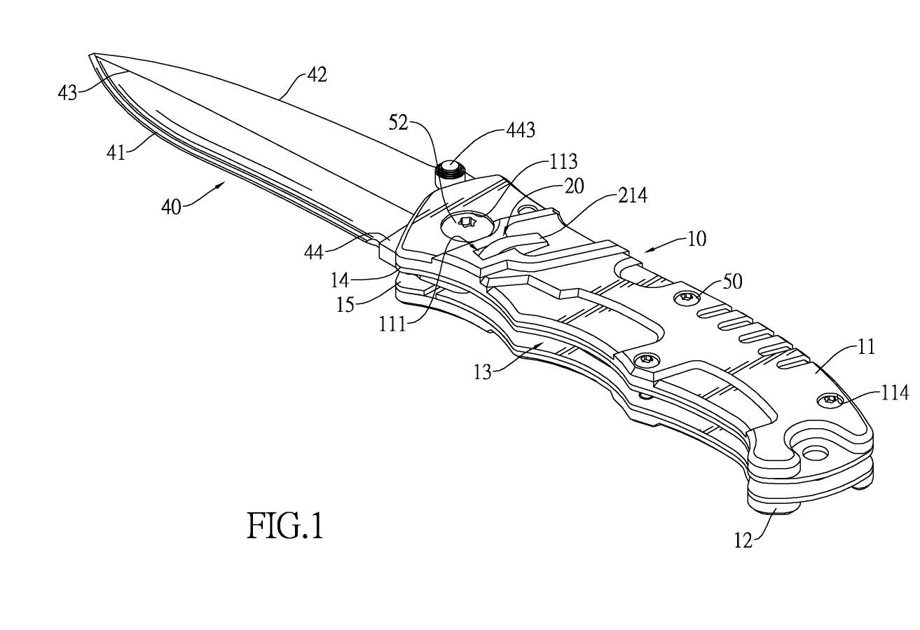

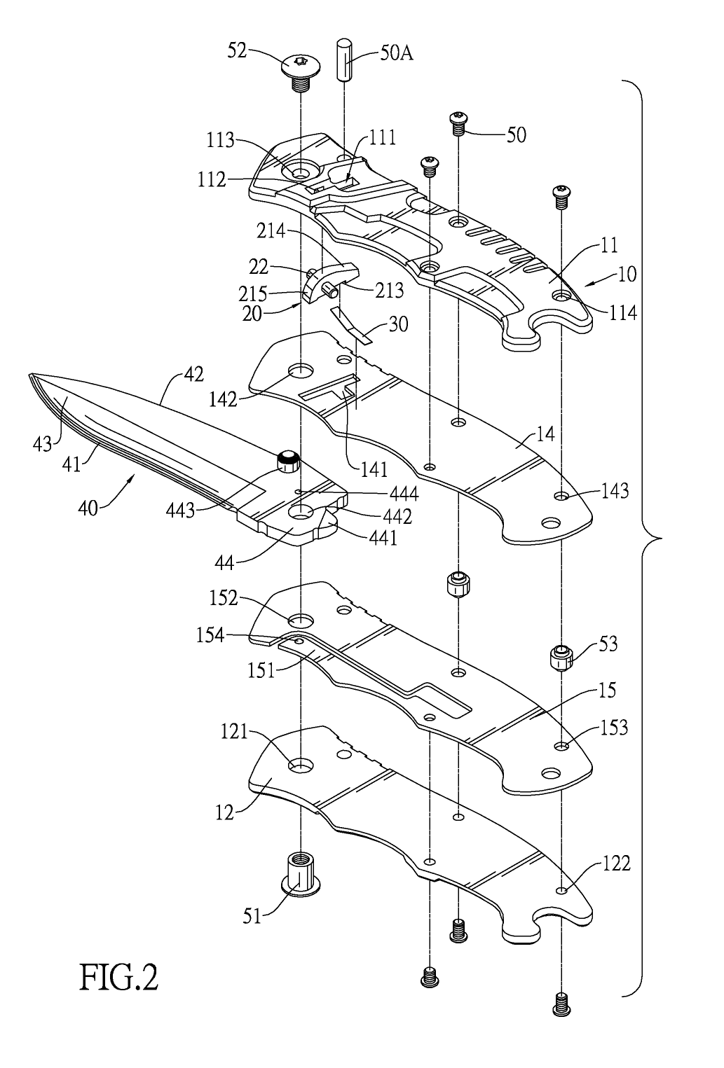

With reference to FIGS. 1 and 2, a folding knife with a lock mechanism in accordance with the present invention comprises a hilt (10), a block (20), a resilient sheet (30) and a blade (40).

The hilt (10) has a first cover (11), a second cover (12), a chamber (13), a first casing (14) and a second casing (15). The first cover (11) has an outside, an inside, a containing hole (111) and a gap (112). The containing hole (111) is formed through the first cover (11). The gap (112) is formed on the inside of the first cover (11) and communicates with the containing hole (111) of the first cover (11). The second cover (12) is attached to the first cover (11) and has an outside and an inside. The chamber (13) is defined between the first cover (11) and the second cover (12). The first casing (14) is mounted on the inside of the first cover (11) and has a receiving hole (141). The receiving hole (141) corresponds to the containing hole (111) of the first cover (11). The second casing (15) is mounted on the inside of the second cover (12) and has a side and a resilient slice (151). The resilient slice (151) is formed on the side of the second cover (12) and has a boss (154).

In a preferred embodiment, the first and second covers (11, 12) have pivot holes (113, 121) and multiple locating holes (114, 122). The first and second casings (14, 15) have pivot holes (142, 152) and multiple locating holes (143, 153). Supports (53) are mounted in the chamber (13) and correspond to the locating holes (114, 122, 143, 153). Fasteners (50) such as, but not limited to screws, are mounted through the locating holes (114) of the first cover (11) and the locating holes (143) of the first casing (14), or are mounted through the locating holes (122) of the second cover (12) and the locating holes (153) of the second casing (15), and then mounted in the support (53) to position the first cover (11), the first casing (14), the second cover (12) and the second casing (15). A pin (50A) is mounted through a group of aligned locating holes (114, 143, 153, 122) in the first cover (11), the first casing (14), the second casing (15) and the second cover (12) to position the first cover (11), the first casing (14), the second casing (15) and the second cover (12) in sequence.

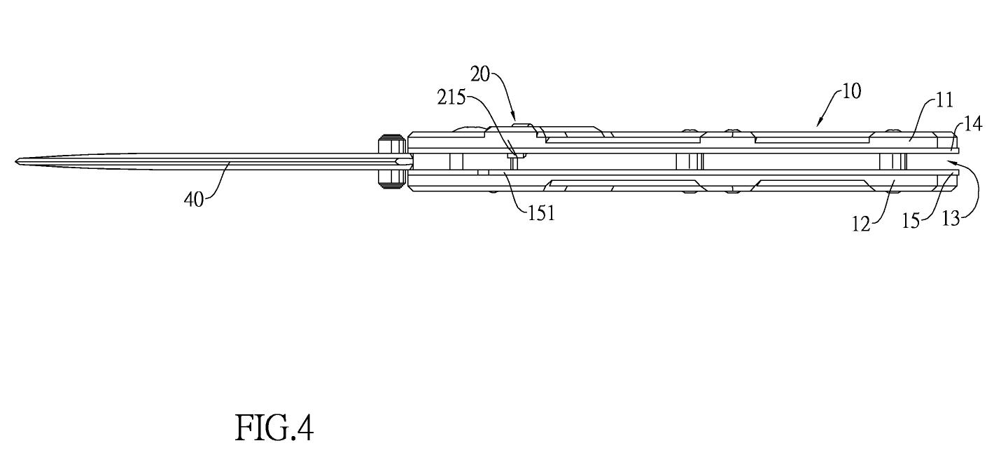

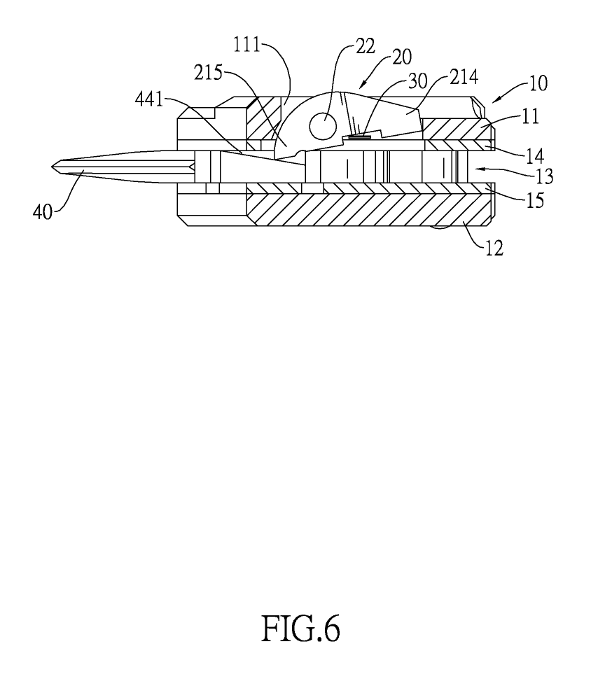

With further reference to FIGS. 4 and 6, the block (20) is mounted through the containing hole (111) of the first cover (11) and the receiving hole (141) of the first casing (14) of the hilt (10) and the block (20) has an upper surface, a lower surface, two sides, a recess (213), a pressed end (214), an abutting end (215) and a pivot (22). The recess (213) is formed in the lower surface of the block (20). The pivot (22) is mounted in the gap (112) of the first cover (11) of the hilt (10) and has two ends respectively protruding from the sides of the block (20). The upper surface of the block (20) protrudes from the outside of the first cover (11) to facilitate pressing thereof.

The resilient sheet (30) is curved and is mounted in the hilt (10) and has two sides. One side of the resilient sheet (30) is mounted between the first cover (11) and the first casing (14) of the hilt (10) being adjacent to the block (20). The other side of the resilient sheet (30) is mounted in the recess (213) of the block (20).

The blade (40) is mounted pivotally between the first cover (11) and the second cover (12) of the hilt (10) and has two sides, an edge (41), a back (42), a point (43) and a tang (44). The tang (44) has a slope (441), a pivot hole (442), two rods (443) and a locating hole (444). The slope (441) abuts the abutting tang (215) of the block (20). The pivot hole (442) and the locating hole (444) are formed through the tang (44) of the blade (40). The rods (443) are respectively attached to the sides of the blade (40) near the tang (44) for convenient operation. The locating hole (444) corresponds to and engages the boss (154) of the second casing (15).

The blade (40) and the hilt (10) are connected pivotally to each other by using a countersunk nut (51) mounted through the pivot hole (121) of the second cover (12), the pivot hole (152) of the second casing (15), the pivot hole (442) of the blade (40), the pivot hole (142) of the first casing (14) and the pivot hole (113) of the first cover (11). A countersunk bolt (52) is mounted in the countersunk nut (51).

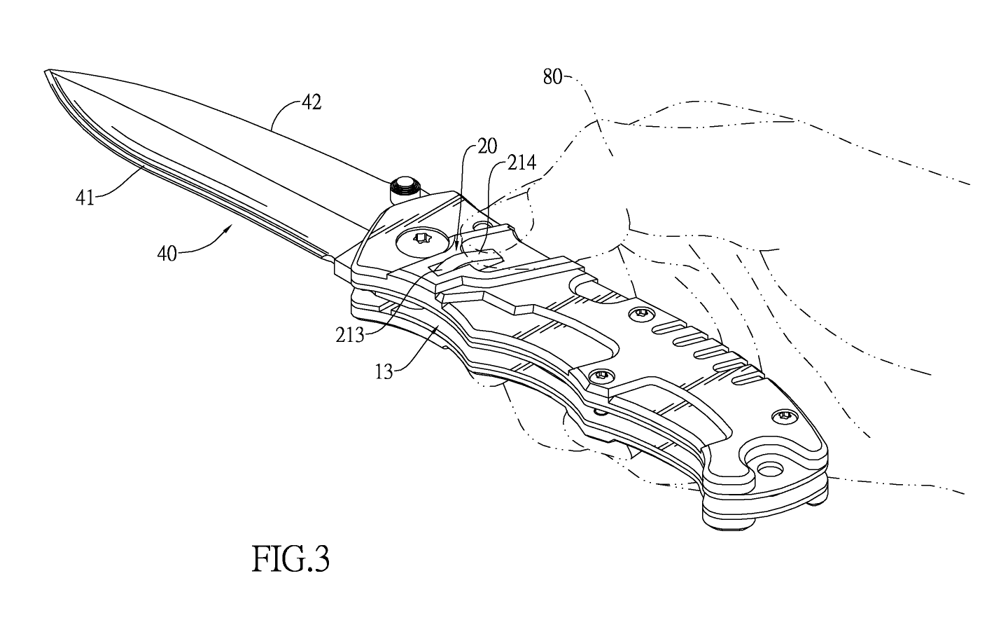

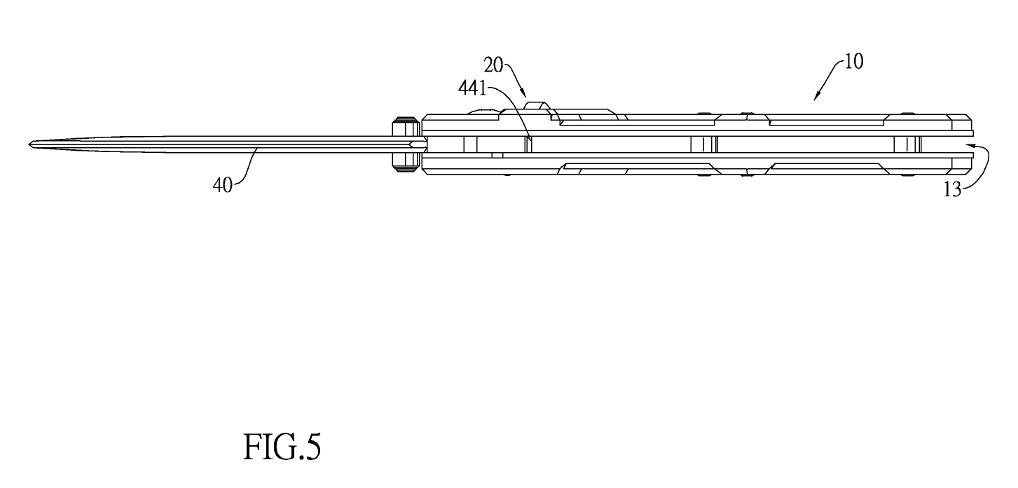

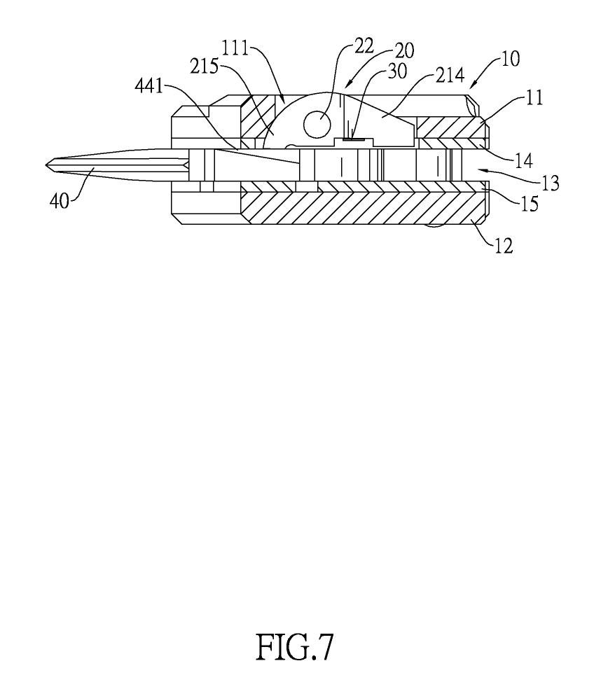

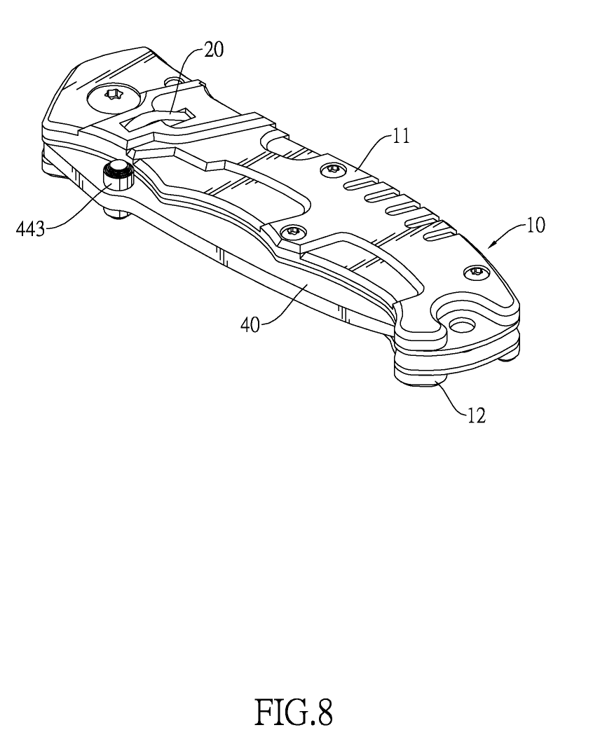

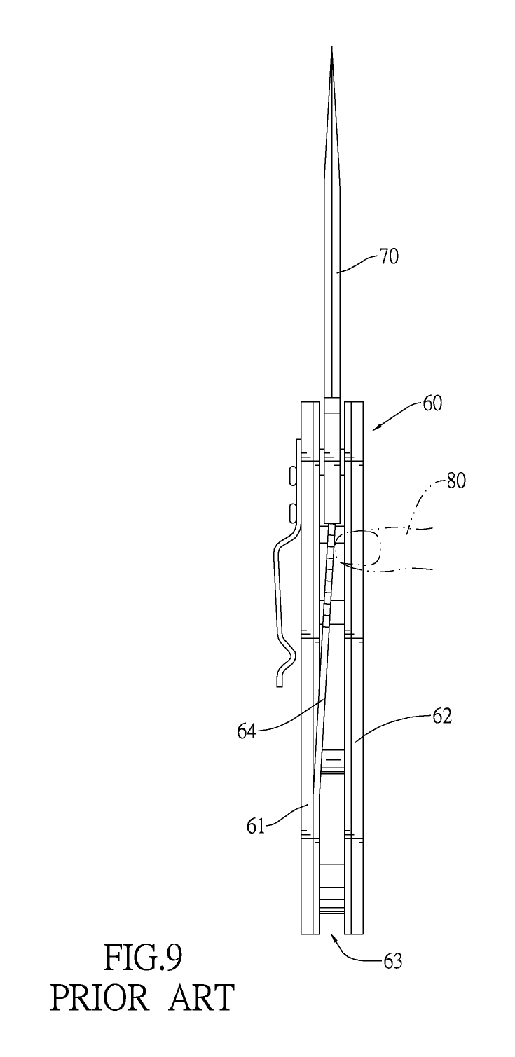

With reference to FIGS. 3, 5, 7 and 8, the blade (40) is pivoted out. The boss (154) of the second casing (15) of the hilt (10) disengages from the locating hole (444) of the blade (40). The blade (40) abuts the pin (50A). The block (20) abuts the slope (441) of the blade (40).

When the folding knife in accordance with the present invention is held in one hand and a thumb (80) used to press the pressed end (214) of the block (20), the pressed end (214) of the block (20) leaves the slope (442) of the blade (40), and the resilient sheet (30) is pressed to have a resilient force. Then a forefinger may be used to press the back (42) of the blade (40) to pivot into the chamber (13) of the hilt (10).

The block (20) and the resilient sheet (30) with the first cover (11) and the first casing (14) are formed as a lock mechanism in accordance with the present invention. Therefore, when operating the folding knife in accordance with the present invention folded in one hand, the thumb (80) presses the block (20) on the outside of the first cover (11) of the hilt (10) and is not on a pivoting path of the blade (70) so is not cut by the blade (70). Moreover, the block (20) and the resilient sheet (30) are hard and abut the blade (40) stably. So the folding knife can be used and folded safely.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A folding knife with a lock mechanism comprising:
a hilt having
a first cover having
an outside;
an inside;
a containing hole formed through the first cover; and
a gap formed on the inside of the first cover and communicates with the containing hole of the first cover;
a second cover attached to the first cover and having
an outside; and
an inside;
a chamber defined between the first cover and the second cover;
a first casing mounted on the inside of the first casing and having
a receiving hole corresponding to the containing hole of the first cover; and
a second casing mounted on the inside of the second casing;
a block mounted through the containing hole of the first cover and the receiving hole of the first casing of the hilt and having
an upper surface;
a lower surface;
two sides;
a pressed end;
an abutting end; and
a pivot mounted in the gap of the first cover of the hilt and having two ends respectively protruding from the sides of the block;
a resilient sheet being curved and mounted in the hilt and having
two sides, wherein one of the sides is mounted between the first cover and the first casing of the hilt; and
a blade mounted pivotally between the first cover and the second cover of the hilt and having a tang abutted by the abutting end of the block.

2. The folding knife with a lock mechanism as claimed in claim 1, wherein
the block further has a recess formed in the lower surface of the block; and
one of the sides of the resilient sheet is mounted in the recess of the block.

3. The folding knife with a lock mechanism as claimed in claim 1, wherein the tang of the blade further has a slope abutted by the abutting end of the block.

4. The folding knife with a lock mechanism as claimed in claim 2, wherein the tang of the blade further has a slope abutted by the abutting end of the block.

5. A lock mechanism comprising:
a hilt having
a first cover having
an inside;
a containing hole formed through the first cover; and
a gap formed on the inside of the first cover and communicates with the containing hole of the first cover;
a first casing mounted on the inside of the first casing and having
a receiving hole corresponding to the containing hole of the first cover; and
a block mounted through the containing hole of the first cover and the receiving hole of the first casing of the hilt and having
a lower surface;
two sides; and
a pivot mounted in the gap of the first cover of the hilt and having two ends respectively protruding from the sides of the block; and
a resilient sheet being curved, mounted in the hilt, being adjacent to the block and having
two sides, wherein one of the sides is mounted between the first cover and the first casing of the hilt.

6. The lock mechanism as claimed in claim 5, wherein
the block further has a recess formed in the lower surface of the block; and
one of the sides of the resilient sheet is mounted in the recess of the block.
